(19) United States
(12) Patent Application Publication
(10) Pub. No.: US 2017/0010130 A1
(43) Pub. Date: Jan. 12, 2017

(54) PLIABLE CAPACITIVE STRUCTURE APPARATUS AND METHODS

(71) Applicants: Daniel XU, Arkles Bay (NZ); Iain Alexander ANDERSON, Titirangi (NZ); Ho Cheong LO, East Tamaki (NZ); Thomas Gregory MCKAY, Onehunga (NZ); AUCKLAND UNISERVICES LIMITED, Auckland (NZ)

(72) Inventors: Daniel Xu, Arkles Bay (NZ); Iain Alexander Anderson, Titirangi (NZ); Ho Cheong Lo, East Tamaki (NZ); Thomas Gregory McKay, Onehunga (NZ)

(21) Appl. No.: 15/113,411

(22) PCT Filed: Jan. 20, 2015
(86) PCT No.: PCT/NZ2015/050001

§ 371 Date: Jul. 21, 2016

(30) Foreign Application Priority Data
Jan. 22, 2014 (NZ) 620243
Feb. 11, 2014 (NZ) 621121
Feb. 25, 2014 (NZ) 621691

(51) Int. Cl. G01D 5/241; A41D 19/00; G06F 3/044; G06F 3/01; G01B 7/16; G01L 1/14

(52) U.S. Cl. CPC G01D 5/241; G01B 7/22; G01L 1/14; G06F 3/044; G06F 3/014; G06F 3/017; A41D 19/0027; G01N 27/226

(57) ABSTRACT

The present invention relates to pliable capacitive structures such as dielectric elastomers and similar smart materials which can be used for sensing externally applied strains which can be inferred by the determining the capacitance of the structure/material. There is provided an apparatus comprising a pliable capacitive structure for use in detecting shape or strain changes, the pliable capacitive structure having a dielectric material positioned between two electrodes; means for applying a steady-state voltage across the two electrodes; and means for determining changes in capacitance of the pliable capacitive structure using said steady state voltage.

### FIELD

The present invention relates to pliable capacitive structures such as dielectric elastomers and similar smart materials which can be used for generating strain in artificial muscle applications for example. Such structures or materials can also be used for sensing externally applied strains which can be inferred by determining the capacitance of the structure or material.

### BACKGROUND

Dielectric elastomers are typically used as physical actuators which change shape or strain when appropriate voltages are applied. Such smart materials can also be used as soft strain sensors in which the capacitance of the dielectric elastomer can be used to infer the strain of the material hence giving it sensing capabilities. The dielectric elastomers (DE) are made from electroactive polymers with muscle like capabilities. Like biological muscles their state (shape) can be sensed giving them pressure sensing abilities. DE comprise two conducting electrodes with a soft insulating or dielectric material sandwiched between. Both the dielectric and electrode materials are flexible allowing the dielectric elastomer structure to bend and stretch. However, accurately measuring the capacitance is a complex task because of the resistive components in the dielectric elastomer (FIG. 1). The dielectric elastomer can be modelled as a capacitance C, a series resistance Rs, and a parallel resistance (across the dielectric material) Rp. However the capacitance of a DE is not straightforward to measure as the electrodes are typically made with carbon based particles to maintain conductivity at large strains. This resistance can be hundreds of kilo-ohms and is strain dependent. Existing methods rely on complicated post-processing, precise magnitude and phase measurements or impedance sweeps. However these methods are computationally intensive, thereby relatively slow and expensive to implement, thus limiting the rate of capacitive feedback and scalability.

Known sensing systems include: T. A. Gisby, B. M. O'Brien, and I. a. Anderson, “Self sensing feedback for dielectric elastomer actuators,” Appl. Phys. Lett., vol. 102, no. 19, p. 193703, 2013; C. Keplinger. M. Kaltenbrunner, N. Arnold, and S. Bauer, “Capacitive extensometry for transient strain analysis of dielectric elastomer actuators,” Appl. Phys. Lett., vol. 92, no. 19, p. 192903, 2008; and H. Haus, M. Matysek, H. Möβinger, and H. F. Schlaak, “Modelling and characterization of dielectric elastomer stack actuators,” Smart Mater. Struct., vol. 22, no. 10, p. 104009, October 2013.

The reference to any prior art in the specification is not, and should not be taken as, an acknowledgement or any form of suggestion that the prior art forms part of the common general knowledge in any country.

### SUMMARY

It is an object of a preferred embodiment of the invention to provide an apparatus and method which will overcome or ameliorate problems with such at present, or to at least provide the public with a useful choice. In an aspect there is provided an apparatus for use in detecting shape or strain changes. The apparatus comprises a pliable capacitive structure having a dielectric material positioned between two electrodes, means for applying a steady-state voltage across the two electrodes, and means for determining changes in capacitance of the pliable capacitive structure using said steady state voltage.

By sensing changes in capacitance of the pliable capacitive structure, changes in strain or shape of the structure can be inferred. This can be useful in user interface and other applications. This is achieved in embodiments by detecting the total charge or integrated current whilst a steady state voltage is applied across the electrodes. The steady state voltage is a substantially constant DC voltage as opposed to a step voltage change.

In an embodiment, the means for determining changes in capacitance comprises means for determining current flow to or from the pliable capacitive structure. This may be implemented using a simple and cheap analogue circuit for integrating the current flowing to (or from) the pliable capacitive structure, which can be used to determine changes in capacitance. In alternative embodiments digital processing may be used instead.

The pliable capacitive structure may be a dielectric elastomer.

In an embodiment the applied steady-state voltage may be less than 600V, or more preferably less than 100V, or more preferably less than 24V, or more preferably less than 5V.

In an embodiment the apparatus further comprises means for periodically resetting the applied steady-state voltage.

In an embodiment the apparatus further comprises means for determining a series resistance of the pliable capacitive structure and using the determined series resistance for determining changes in capacitance of the pliable capacitive structure.

This may be implemented using a means for determining a peak current in response to a change in the voltage applied across the two electrodes.

In another aspect there is provided a system having a plurality of the above defined apparatus. These may be integrated into a user interface such as a touch pad or a glove for example.

In an embodiment at least two of the pliable capacitive structures are arranged into opposing pairs and the system further comprises means for determining differential changes in capacitance of the pairs.

In another aspect there is provided a method of operating an apparatus for detecting shape or strain changes, the apparatus comprising a pliable capacitive structure having a dielectric material positioned between two electrodes. The method comprises applying a steady-state voltage across the two electrodes and determining changes in capacitance of the pliable capacitive structure using said steady state voltage.

In an embodiment determining changes in capacitance comprises determining the charge on the pliable capacitive structure. This may be implemented by integrating the current flowing to the pliable capacitive structure.

In an embodiment the method further comprises determining a series resistance of the pliable capacitive structure by determining a peak current in response to a change in the voltage applied across the two electrodes, and determining changes in capacitance of the pliable capacitive structure using the determined series resistance.

In another aspect there is provided a pliable capacitive structure for use in detecting shape or strain changes, the pliable capacitive structure having a dielectric material positioned between two electrodes. The sensor comprises means for applying a low voltage across the two electrodes and for determining the capacitance of the pliable capacitive structure by integrating the current flowing into the pliable capacitive structure following application of the low voltage.

In an embodiment the low voltage is less than 600V. In further embodiments the low voltage is less than 100V, or 24V or 5V. The low voltage may be less than the driving voltage of the pliable capacitive structure when also used as an actuator. By using a sufficient low voltage, the effect of the internal; parallel resistance of the pliable capacitive structure is significantly reduced such that it can be ignored in calculating the capacitance. The internal parallel resistance can undergo large changes, especially in actuator dielectric elastomers under high strain, and can therefore significantly affect the accuracy of the estimates based on current integration methods.

In yet another aspect there is provided a touch sensor for detecting tactile input and having: a number of dielectric elastomers (DE) arranged into opposing pairs; capacitance determining means arranged to determine a differential capacitance between respective opposing pairs of DE.

In embodiments, the capacitance determining means noted above and described within this specification may be used. Alternatively any suitable capacitance determining means may be employed, including for example: capacitance from gain and phase shift of a sinusoidal input; capacitance from impedance frequency response; capacitance from Hyper-plane approximation; capacitance from current integration following application of a step voltage. Such alternative methods are described in the above referenced documents, which are incorporated herein by reference.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

### BRIEF DESCRIPTION OF DRAWINGS

FIG. 1 illustrates a known dielectric elastomer and equivalent electric circuit;

FIG. 2 illustrates capacitor voltage during a transient period following a step change;

FIG. 3 illustrate capacitor current and charge following a step change in voltage;

FIG. 4 illustrates a simple current sensing circuit;

FIG. 5 illustrates an analogue implementation of a first embodiment;

FIG. 6 illustrates another analogue implementation of a second embodiment;

FIG. 7 illustrates resetting the supply voltage;

FIG. 8 illustrates an analogue implementation of a peak detector to measure Rs which can be used in modified first or second embodiments;

FIG. 9 illustrates a digital signal processing (DSP) implementation embodiment;

FIG. 10 illustrates a flow chart for an algorithm applied by the DSP;

FIG. 11 illustrates a touch-pad application according to a further embodiment;

FIG. 12 shows a potential state of the touch-pad of FIG. 11;

FIG. 13 illustrates a circuit implementation for the fourth embodiment;

FIG. 14 illustrates changes of charge in a dielectric elastomer (DE) under constant voltage in response to changes of shape;

FIG. 15 illustrates changes of capacitance and charge of the DE of FIG. 14 in response changes of shape and applied voltage;

FIG. 16 illustrates a hand or glove application according to another embodiment;

FIG. 17 illustrates an alternative current integrating circuit; and

FIG. 18 illustrates a further alternative current integrating circuit.

### DETAILED DESCRIPTION

Detecting changes in shape or strain of smart materials such as dielectric elastomers (DE) can be used in a wide variety of applications, for example touch sensors and actuators. Capacitive sensing methods are typically used to infer changes in shape capacitance is closely linked to both the overlapping area and the distance separating the electrodes. Although capacitive sensing circuits for DE are available, they tend to be complex and or require relatively high power, especially for low cost portable applications such as hand sensing. Such applications require a large number of DE to detect hand movements in numerous directions, and therefore low cost, low power consumption, and high scalable solutions are desirable.

Many of the capacitance estimation methods referenced above require complex processing necessitating a processor. Whilst current integration following an applied step voltage can be implemented using simple electronics, this does require regular charging and discharging of the DE in order to measure the capacitance. Furthermore the measurement estimate must await a 3RC time constant until steady state is achieved before the integrated current can be determined in order to estimate capacitance.

The embodiments provide a modification of the current integration method which replaces the square wave sensing voltage with a constant DC voltage and continuously tracks the movement of charge to and from the DE. Under a constant or steady-state DC voltage, changes to capacitance (as a result of strain or shape changes) are proportionally reflected as a movement of charge. Current is continuously integrated to determine the changing total charge on the DE. This is much faster as changes in capacitance can be determined immediately from changes in the integrated current (or charge on the DE) without having to wait for the DE to be fully discharged then fully charged. Furthermore using the steady-state voltage to determined changes in the capacitance avoids unnecessary losses through the internal series resistance of the DE.

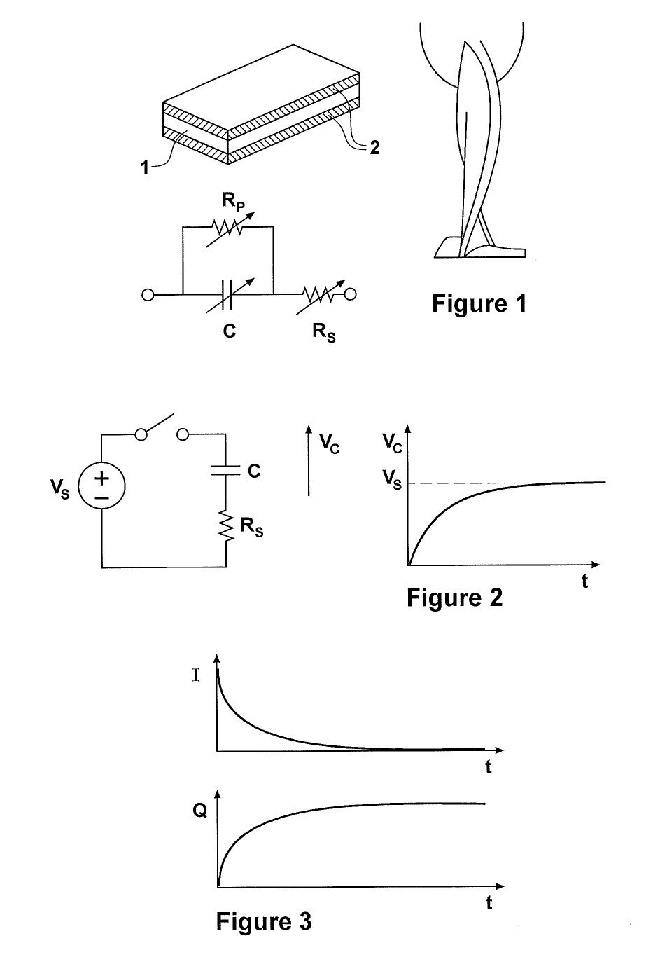

Referring to FIG. 1, DE are constructed by sandwiching a soft dielectric material 1 between compliant electrodes 2, thereby resembling a flexible capacitor. As shown, a simple DE can be modeled as a capacitor C having an internal series resistance Rs and an internal parallel resistance Rp. To accurately measure the DE's capacitance while any current is flowing through the DE, its electrode resistance also needs to be measured at the same time. This is because the electrode resistance causes an internal voltage drop, which cannot be measured directly. Common sensing methods that account for this include measuring the gain and phase shift of a sinusoidal voltage input, the impedance frequency response and a linear regression on the DE's voltage and current output from a period of arbitrary excitation.

The known current integration following voltage step methods commonly do not account for these internal resistances and can therefore result in inaccurate capacitance estimates. However when operated under low voltages, the DE electrical model simplifies to a variable resistor (R_{S}) in series with a variable capacitor (C). The inventors have discovered this to be a valid assumption for low voltage sensing applications. Furthermore by applying a low steady-state voltage and determining changes in capacitance rather than the capacitance on the DE following application of each step voltage, changes in DE strain can be detected rapidly, with low power consumption, using simple and cheap analogue electronics, and being highly scalable as described in the following embodiments.

For DE applications, the parallel resistance Rp may be neglected when it is much larger than the impedance of the capacitor. For some DE applications this may be less than 600V. In some embodiments this may be less than 100V. The method works well with off-the-shelf electronics which are typically below 24V or 5V.

Unobtrusive strain feedback can be obtained by measuring capacitance, a geometric property related to the overlapping area of the electrodes (A), thickness of the membrane (d), relative permittivity (∈ᵣ) and the permittivity of free space (∈₀) (1).

$$C = \frac{{ɛ}_{r} {ɛ}_{0} A}{d} \qquad Equation ( 0 )$$

Referring to FIGS. 2 and 3, the following embodiments assume negligible leakage current through the parallel membrane resistance (R_{P}) of the dielectric elastomer. While this may be invalid for the high voltages (kV) used for actuation, as noted the inventors have discovered this to be a valid assumption for low voltage sensing applications.

The capacitance of a dielectric elastomer can be calculated from the governing capacitor charge/voltage equation, where Q is the amount of electrical charge stored on the capacitor and V the voltage across the capacitor.

$$C = \frac{Q}{V} \qquad Equation ( 1 )$$

The voltage on a capacitor cannot change instantaneously. When the switch in FIG. 2, is closed (simulating a step response), the voltage on the capacitor (V_{C}) will exponentially increase to the supply voltage (V_{S}) after approximately 3 RC time constants (within 95%). This transient period is typically less than 1 ms. For example a typical sensor of 200 pF with a 50 kΩ electrode resistance has an RC time constant of 10 μs.

The current profile from the step response is an initial transient spike with an exponential decay to zero (FIG. 3). The integral of this current represents the charge placed on the capacitor (Q).

Q=∫idt Equation (2)

The series electrode resistance Rs can be calculated from the peak of the current spike

$${R}_{s} = \frac{{V}_{s}}{{I}_{peak}} \qquad Equation ( 3 )$$

The capacitance of the dielectric elastomer at any instant in time can be calculated by

$$C = \frac{Q}{{V}_{C}} \qquad Equation ( 4 )$$

The voltage across the capacitor (V_{C}) can be calculated by subtracting the voltage drop across the electrode resistance from the supply voltage (V_{S})

V_{C}=Vₛ−IRₛ Equation (5)

Substituting for V_{C}, the instantaneous capacitance |[TG1] can be calculated by

$$C = \frac{\int I d t}{{V}_{s} - {IR}_{s}} \qquad Equation ( 6 )$$

Once the capacitor is fully charged and is at steady state, e.g. after the transient period, the current drops to zero and the capacitor voltage (V_{C}) is then equal to the supply voltage (V_{S}). This can be determined by monitoring the absolute value of the current. Furthermore, provided any mechanical deformation is slow relative to the RC time constant of the pliant capacitor, any current induced by changes in capacitance due to mechanical deformation once it is substantially fully charged will be negligible relative to the transient currents due to charging the capacitor, thus the internal voltage drop across the series resistance (Rs) will also typically be negligible, and capacitor voltage (Vc) is still substantially equal to the supply voltage (Vs). For a capacitor in the fully charged state, therefore, the previous equation simplifies to

$$C = \frac{\int I d t}{{V}_{s}} \qquad Equation ( 7 )$$

This equation can be used to instantaneously calculate capacitance provided the mechanical deformation is slow compared to the RC time constant of the dielectric elastomer.

Alternatively, once Equation 3 has been used to determine the series resistance Rs, the standard equation for modelling the charging of a capacitor voltage during the charging phase can be used to determine the capacitance as follows

$${V}_{c} = {V}_{s} ( 1 - {e}^{\frac{- t}{RC}} ) \qquad Equation ( 8 )$$

Rearranging, the capacitance can be determined by Equation 9, using Rs, Vs, Vc, and t which are all known variables from direct measurement or through the use of equations 3 and 5.

$$C = \frac{- t}{{R}_{s} ln ( \frac{{V}_{s} - {V}_{C}}{{V}_{s}} )} \qquad Equation ( 9 )$$

FIGS. 14 and 15 illustrate capacitance and charge changes in a DE in response to changes in strain and/or applied voltage. Once steady-state is achieved (ie the DE capacitor is fully charged), the constant steady-state or DC voltage can be used to determine changes in the DE's capacitance by detecting changes in the movement of charge. As shown, the capacitance C is constant for DE shape 1, but can be measured following the application of an applied voltage V. As shown, the charge Q then increases to a steady state and can then be used to calculate the capacitance C. When the DE is stretched—shape 2—the capacitance C increases and this causes an increase in the charge stored on the DE which is measured to calculate the change in capacitance. When the DE is released—shape 3—the capacitance changes back to that of shape 1, and this change in capacitance is detected by the method by detecting the corresponding change in charge Q.

In the following embodiment, these changes in charge are detected by integrating the current flowing to/from the DE. The integrated current flow following the initial steady-state voltage application will then be increased in response to stretching of the DE, and reduced following compression of the DE. This method of current integration under steady-state applied voltage prevents unnecessary discharging and thus results in shorter transient times compared to charging completely from zero charge. Once the system detects steady state (near constant charge), equation 7 can be used to calculate capacitance. For a typical sensor designed to measure hand motion, the transient period is likely to be much quicker than any hand motion.

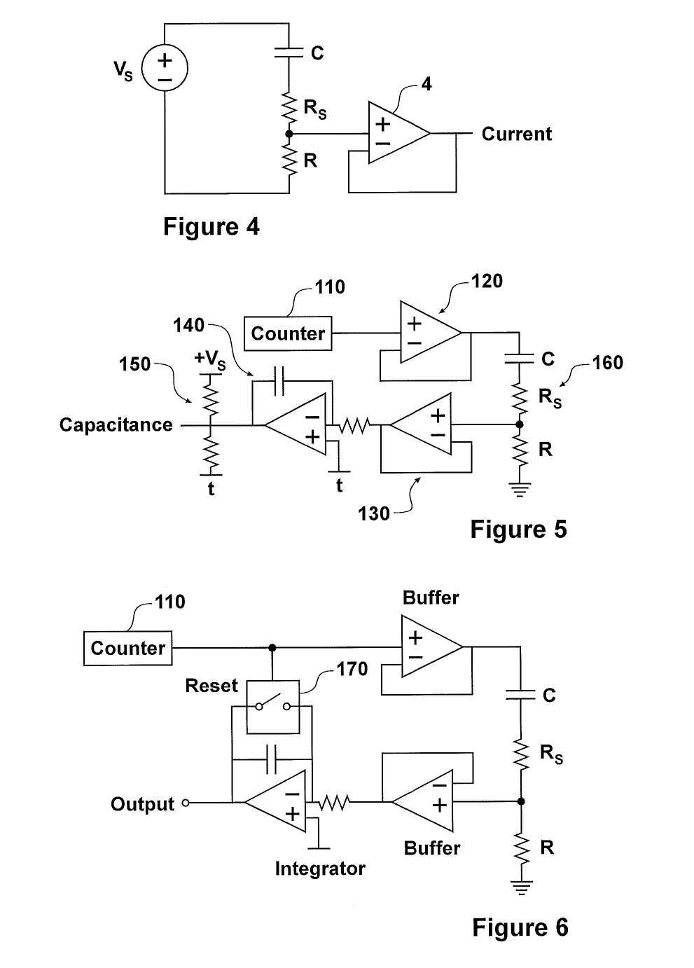

The series current flowing into the DE can be measured through a sensing resistor R and voltage buffer 4 as shown in FIG. 4, and then integrated either in software or in hardware. Although alternative circuits for determining net current flow into the DE may be used.

A simple analogue implementation can be achieved in hardware to give real time capacitive feedback for example using the circuit of FIG. 5. The circuit comprises a voltage supply 110 which is connected to the dielectric elastomer DE 160 (comprising C and Rs) via an op-amp configured as a buffer 120. The DE 160 is connected to a sensing resistor R, across which is connected a second buffer 130 connected to the input of an integrating op-amp 140. The output of the integrating op-amp 140 is connected to a scaling circuit 150 which effectively converts the integrated current value determined by the integrating op-amp into a capacitance value. Current is measured via the sensing resistor R, buffered and integrated by the analog opamp 140. The voltage divider 150 is used to ratio the output to give capacitance.

A simple counter can be used as the supply voltage 110, and which periodically resets. Any drift as a result of the integration can be cleared by periodically resetting the integrator.

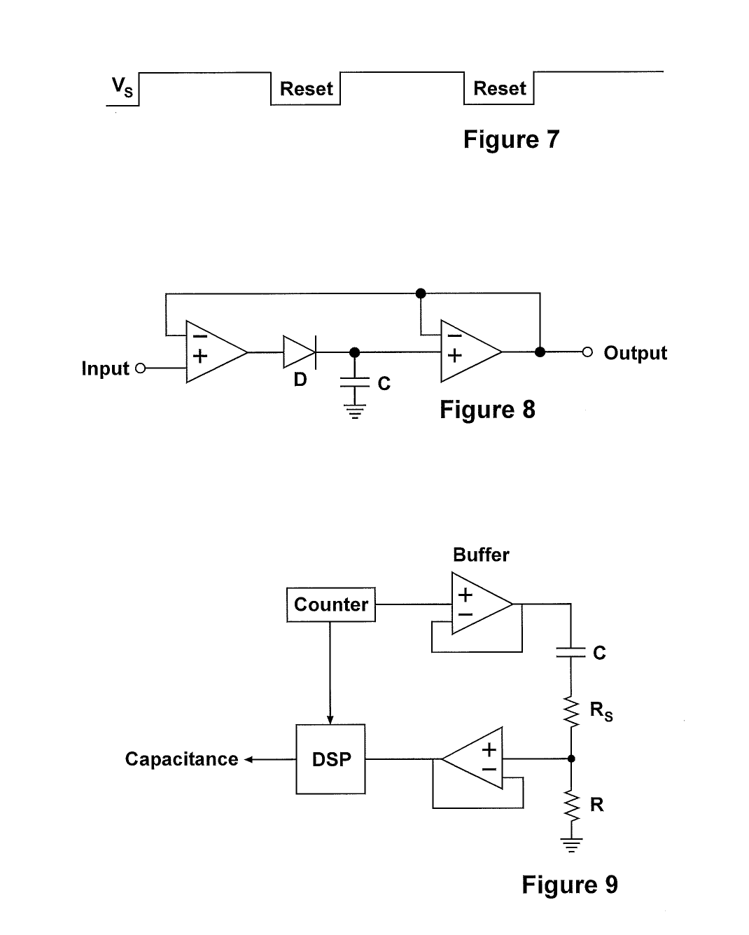

Alternatively as shown in the second embodiment of FIG. 6, the gain of the integrating circuit can be set equivalent of dividing the integral by the constant supply voltage, thereby completing the calculation of capacitance in Equation 7. No external processor is required for these or similar simple analogue implementations, providing a low cost, simple yet fast capacitance sensor. A switching component 170 triggered by the supply voltage (V_{S}) of the counter 110 falling to zero can be used to short-circuit the integrating capacitor circuit. The period of the reset needs to be long enough to fully discharge the capacitor. This period can be determined from measuring the discharge current. An example waveform for the supply voltage with the reset feature is shown in FIG. 7.

The capacitance value provided by these embodiments can then be used to infer the strain and/or shape of the dielectric elastomer (DE). Typically applications include: DE integrated into fabric of glove to assist detecting physical inputs by a user wearing the glove; other motion capture clothing garments; human computer interface devices; augmented reality; robotics control. A low voltage sensor may be embedded inside or as part of an actuator as a dedicated sensing element. Many other applications will be apparent to the skilled person.

A further analogue embodiment may be provided which uses many of the circuit components of the first or second embodiments together with an analogue peak detector circuit as shown in FIG. 8 to capture the magnitude of the Transient current Iₚₑₐₖ. Then a simple division can be used to calculate R_{S} by Equation 3. This will allow an analogue implementation of Equation 6 to be realized. For example from Equation 5, the voltage on the capacitor (Vc) can be calculated if the voltage drop across the series resistor (Rs) is subtracted. To obtain an estimation of R_{S}, an analogue peak detector such as the one in FIG. 8 can be used to measure the maximum value of current when the DE is being charged. Then R_{S} can be calculated using ohms law, knowing the driving voltage (V_{S}).

$$Rs = \frac{Vs}{{l}_{Maximum}}$$

With knowledge of Rs during the charging period, capacitance can then be calculated from Equation 6.

A digital embodiment is shown in FIG. 9, in which the equations are performed in the digital domain by a suitable processor such as a DSP. This can be arranged to allow for determining of capacitance during both the transient and steady state period. Many of the circuit components are the same as the first embodiment, but the integrating op amp is replaced with a digital signal processor (DSP) or other processor. The DSP receives a current measurement input I and typically a counter input to determine the start of a transient period.

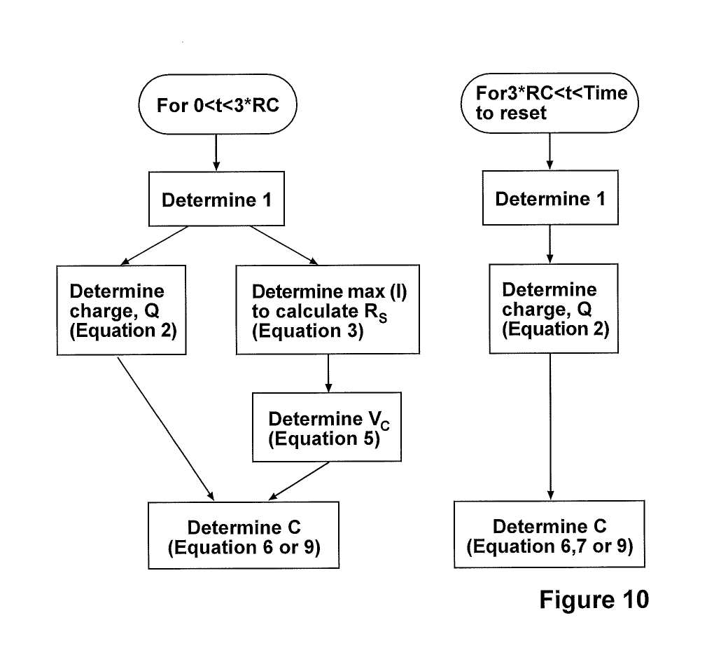

A flowchart for a DSP algorithm to apply this method is shown in FIG. 10. However alternative algorithms may be employed with benefit from the teachings of this document. During the transient period (0<t<3*RC), the DSP implements the algorithm shown to calculate capacitance. The series resistance Rs is determined according to Equation 13 after determining the peak current Iₚₑₐₖ Equation 7 or 9 can then be used to calculate the capacitance. After the transient period (3*RC<t<Time to reset), the DSP implements the simplified algorithm to determine capacitance as shown. Equation 7 or 9 can then be used to calculate changes in capacitance using the steady state applied voltage.

As noted, these embodiments provide a number of advantages, including: simple; inexpensive; highly scalable; fast feedback; entire systems of multiple sensors implementable in hardware for real time and analogue output; only current needs to be measured; constant supply voltage; works with all dielectric elastomer configurations, including stacks.

A plurality of sensors as described above may be used in a system to provide a multiple channel pressure sensing device, for example as might be utilised in a glove for detecting hand gestures which can then be used to control a suitable user interface.

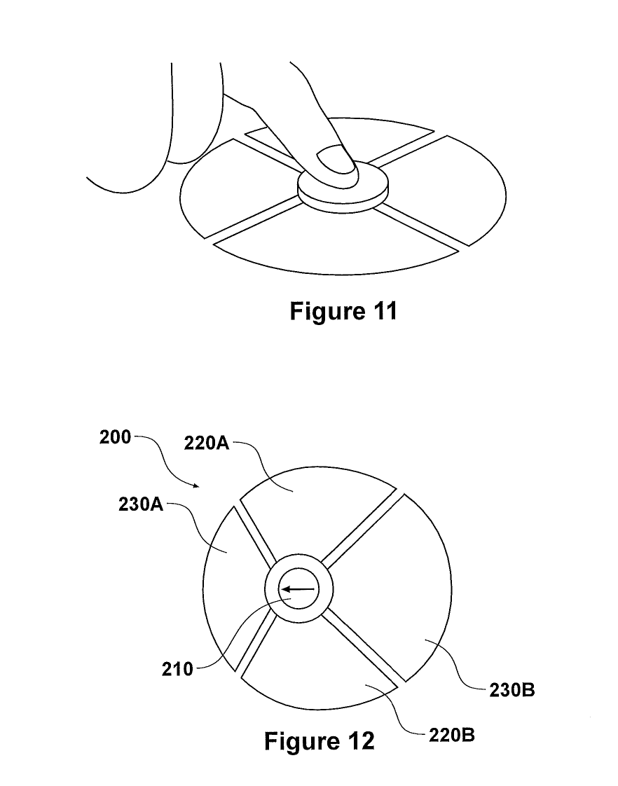

Referring now to FIGS. 11-13, an embodiment is shown to measure tactile motion, having a touchpad for receiving user inputs. The touchpad 200 has a circular configuration with sensors 220A-230B were arranged in opposing pairs—220A and 220B, 230A and 230B. By measuring the differential capacitance of opposing pairs, in-plane motion can be decoupled and sensitivity doubled through multiple capacitance change inputs from the out-of-plane motion. When the center hub 210 is displaced to the left (FIG. 12), the capacitance of the left sensor (220A) decreases due to a reduction in area and while the capacitance of the right sensor (220B) increases. At the same time, the top (230A) and bottom (230B) sensors change by the same amount, hence their differential capacitance equals zero. Due to the symmetrical design, out of plane pressure can be determined by summing the total change in capacitance in all four sensors.

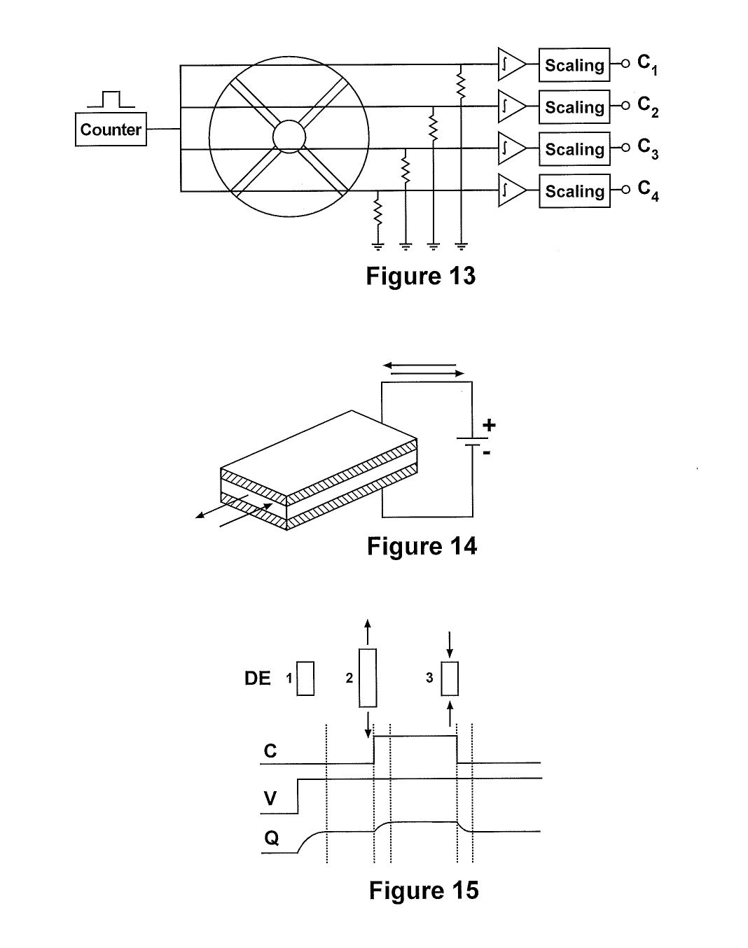

Using the simplified charge integration method of equation (9), a hardware only implementation of measuring touch on the DE touchpad is shown in FIG. 13. The sensors rely on a common excitation voltage, which is generated from a digital counter. Analogue integrators and scalars are used to convert the displacement into capacitance. Thus for example four parallel circuits from FIG. 5 or 6 may be employed. This implementation is compact and portable, with no requirement on external processors. It can also be seen that such an apparatus is easily scalable to include many pressure sensing channels.

A similar arrangement is used in the application embodiment of FIG. 16, in which multiple DE are applied directly to a user's hand, or a glove, and the sensing circuits of FIGS. 5, 6, 9 or similar implementations are used to determine total capacitance and or capacitance changes for each DE. These may then be summed as described above, or utilised in more complex ways to determine hand gestures and other parameters.

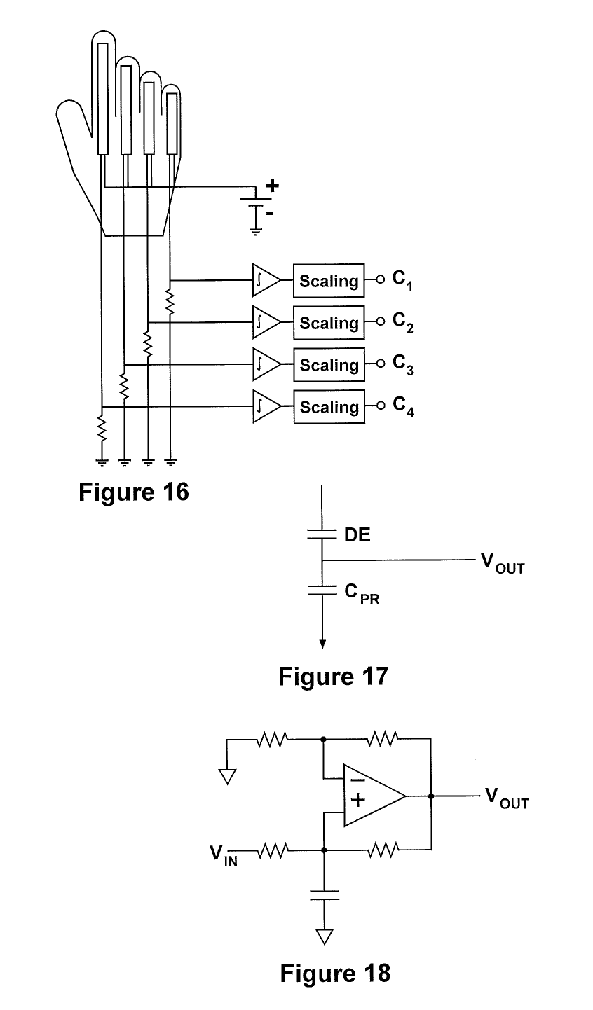

Although various circuits have been described, alternative circuits which measure capacitance changes according to the invention will now be readily understandable and achievable to those skilled in the art. Such alternative circuit arrangements also fall within the scope of this invention. For example a precision capacitor (C_{PR}) can be connected in series with the DE as shown in FIG. 17, and which performs the same function of integrating the current. The charge on the DE is calculated by integrating the current flowing onto it. One hardware approach to do this is to place a precision capacitor of a known capacitance in series with the DE (thereby the same current flows through the DE as the precision capacitor). By measuring the voltage on this precision capacitor, its charge and also the DE's charge can be calculated by

Q=CV

Another circuit that can integrate current is a “Deboo integrator” see FIG. 18. This can be used in place of the precision capacitor (C_{PR}) of FIG. 17 or the integrator (140) in FIG. 5.

Although the current integration method has been described for determining capacitance following a step voltage change from zero to Vs, in other embodiments the step voltage change could be from one non-zero voltage (Vs1) to another non-zero voltage (Vs2). In these embodiments the voltage difference (ΔV) between Vs1 and Vs2 is used in the equations instead of Vs.

Where in the foregoing description, reference has been made to specific components or integers of the invention having known equivalents, then such equivalents are herein incorporated as if individually set forth.

Although this invention has been described by way of example and with reference to possible embodiments thereof, it is to be understood that modifications or improvements may be made thereto without departing from the scope of the invention.

1. An apparatus comprising:
a pliable capacitive structure for use in detecting shape or strain changes, the pliable capacitive structure comprising:
a dielectric material positioned between two electrodes;
means for applying a steady-state voltage across the two electrodes; and
means for determining changes in capacitance of the pliable capacitive structure using said steady state voltage.

2. The apparatus according to claim 1, wherein the means for determining changes in capacitance comprises means for determining current flow to or from the pliable capacitive structure.

3. The apparatus according to claim 2, wherein the means for determining current flow comprises means for integrating the current flowing to the pliable capacitive structure.

4. The apparatus according to claim 1, wherein the pliable capacitive structure is a dielectric elastomer.

5. The apparatus according to claim 1, wherein the applied steady-state voltage is less than 600V.

6. The apparatus according to claim 1, further comprising means for periodically resetting the applied steady-state voltage.

7. The apparatus according to claim 1, wherein the means for determining changes in capacitance is implemented using analog electronics.

8. The apparatus according to claim 1, further comprising:
means for determining a series resistance of the pliable capacitive structure and using the determined series resistance for determining changes in capacitance of the pliable capacitive structure.

9. The apparatus according to claim 8, wherein the means for determining a series resistance comprises means for determining a peak current in response to a change in the voltage applied across the two electrodes.

10. A system comprising a plurality of apparatus according to claim 1, the system comprising one or more of the following: a touch pad; a glove.

11. The system according to claim 10, wherein at least two of the pliable capacitive structures are arranged into opposing pairs and the system comprising means for determining differential changes in capacitance of the pairs.

12. A method of operating an apparatus for detecting shape or strain changes, the apparatus comprising a pliable capacitive structure having a dielectric material positioned between two electrodes, the method comprising:
applying a steady-state voltage across the two electrodes; and
determining changes in capacitance of the pliable capacitive structure using said steady state voltage.

13. The method according to claim 12, wherein determining changes in capacitance comprises determining current flow to or from the pliable capacitive structure.

14. The method according to claim 12, wherein determining current flow comprises integrating the current flowing to the pliable capacitive structure.

15. The method according to claim 12, wherein the applied steady-state voltage is less than 5V.

16. The method according to claim 12, further comprising:
determining a series resistance of the pliable capacitive structure by determining a peak current in response to a change in the voltage applied across the two electrodes; and
determining changes in capacitance of the pliable capacitive structure using the determined series resistance.
